(19) United States
(12) Patent Application Publication
(10) Pub. No.: US 2024/0255073 A1
(43) Pub. Date: Aug. 1, 2024

(54) BURIED PIPELINE REMOVAL METHOD AND BURIED PIPELINE REMOVAL DEVICE

(71) Applicant: NIPPON TELEGRAPH AND TELEPHONE CORPORATION, Tokyo (JP)

(72) Inventors: Daisaku NISHIYAMA, Tokyo (JP); Kenji HIYOSHI, Tokyo (JP); Koji ITASAKA, Tokyo (JP); Akira ITO, Tokyo (JP)

(73) Assignee: NIPPON TELEGRAPH AND TELEPHONE CORPORATION, Tokyo (JP)

(21) Appl. No.: 18/560,913

(22) PCT Filed: May 18, 2021
(86) PCT No.: PCT/JP2021/018859

§ 371 Date: Nov. 14, 2023

(51) Int. Cl. F16L 1/028; F16L 1/06

(52) U.S. Cl. CPC F16L 1/028; F16L 1/06

(57) ABSTRACT

Provided are an underground pipeline removal device and an underground pipeline removal method capable of selectively removing only unnecessary pipelines. The underground pipeline removal method includes an insertion process of inserting a cutting device into an embedded underground pipe 6 from the front side toward the back side of the underground pipe 6, a cutting process of spirally cutting the underground pipe 6 from the inside with the cutting device to form strip-like cut pieces, and a collection process of drawing out the cut piece from the front side to the outside through the inside of the underground pipe 6.

### TECHNICAL FIELD

The present invention relates to an underground pipeline removal method and an underground pipeline removal device.

### BACKGROUND ART

When an underground pipeline such as a communication line, a power line, a gas pipe, or a water pipe becomes dysfunctional due to aging or the like, it is necessary to update the underground pipeline. A dysfunctional underground pipeline may be removed as an unnecessary underground pipeline (hereinafter, it may be referred to as an unnecessary pipeline) as necessary.

The removal work of the unnecessary pipeline can be performed by excavating the target section and exposing the unnecessary pipeline. However, it is inefficient and costly to perform removal by excavation every time an unnecessary pipeline is generated. Therefore, in order to reduce the excavation work cost required for this removal work, a process (method) capable of removing unnecessary underground pipes at low cost without excavation has been studied.

Non Patent Literature 1 describes a method of crushing and removing aged or dysfunctional pipelines by non-cutting and laying a new pipe by a propulsion method. In this method, a propeller equipped with a crushing head is propelled along an existing pipeline, and the cross section of the existing pipeline is crushed while the crushed pipe is collected, and the laid pipe is replaced with a new pipe.

Non Patent Literature 2 describes a method in which an existing pipeline is gripped by a ripper without cutting open, and the existing pipeline is pulled out via a PC steel material by a pulling device provided in a shaft.

### CITATION LIST

### Non Patent Literature

Non Patent Literature 1: Rebirth Ace Method Ace Mole Method Association, [retrieved on May 8, 2021], the Internet <http://acemole.jp/rebirthace/>
Non Patent Literature 2: Re Cube Mole Sumitomo Mitsui Construction Co., Ltd., [retrieved on May 8, 2021], the Internet <https://www.smcon.co.jp/service/re-cube/>

### SUMMARY OF INVENTION

### Technical Problem

The methods described in Non Patent Literature 1 and Non Patent Literature 2 are techniques suitable for removing a middle-diameter pipeline that is no longer necessary. However, when other pipelines (for example, a small-diameter pipeline) are embedded near the unnecessary underground pipe, for example, along the unnecessary pipelines, it is difficult to remove only the unnecessary pipelines without affecting the other pipelines. In particular, in a case where a plurality of small-diameter pipelines are embedded along the unnecessary pipelines, it is difficult to remove only the unnecessary pipelines. Therefore, it is desired to provide an underground pipeline removal method and an underground pipeline removal device capable of selectively removing only unnecessary pipelines even in a case where there are a plurality of pipelines.

The present invention has been made in view of such an actual situation, and an object thereof is to provide an underground pipeline removal method and an underground pipeline removal device capable of selectively removing only unnecessary pipelines.

### Solution to Problem

An underground pipeline removal method according to the present invention for achieving the above object include
an insertion process of inserting a cutting device into an embedded pipeline from a front side toward a back side of the pipeline,
a cutting process of spirally cutting the pipeline from the inside with the cutting device to form strip-like cut pieces, and
a collection process of drawing out the cut pieces from the front side to the outside through the inside of the pipeline.

The underground pipeline removal method according to the present invention may further
draw, in the collection process, the cut piece into the pipeline from the back side of the pipeline, and the cut piece may be drawn to the outside from an opening at an end portion of the pipeline on the front side through the inside.

The underground pipeline removal method according to the present invention may further
engage, in the collection process, an anchor portion with the cut piece on the back side, and draw out the anchor portion to the outside from an opening at the end portion on the front side of the pipeline to draw out the cut piece to the outside.

The underground pipeline removal method according to the present invention may further include
a heating process of heating the pipeline, in which
the collection process is performed after the heating process.

The underground pipeline removal method according to the present invention may further
heat the pipeline, in the heating process, with water vapor.

An underground pipeline removal device according to the present invention for achieving the above object includes
a cutting device that is inserted into an embedded pipeline from a front side of the embedded pipeline and cuts the pipeline spirally from the inside to form a strip-like cut piece, and
a collection device that draws out the cut piece from the front side to the outside through the inside of the pipeline.

In the underground pipeline removal method according to the present invention,
the collection device may include
   an anchor portion that engages with the cut piece on a back side of the pipeline, and
   a pulling portion that draws out the anchor portion from an opening at the end portion on the front side of the pipeline to the outside through the inside of the pipeline.

In the underground pipeline removal method according to the present invention, the method may further include
a heating device that heats the pipeline, in which
the heating device may include a nozzle portion that supplies water vapor to the inside of the pipeline.

### Advantageous Effects of Invention

It is possible to provide an underground pipeline removal device and an underground pipeline removal method capable of selectively removing only unnecessary pipelines.

### BRIEF DESCRIPTION OF DRAWINGS

FIG. 1 is a diagram illustrating an embedded state of an underground pipe to be removed.

FIG. 2 is a diagram illustrating details of an underground pipe to be removed and a connection portion with the underground pipe manhole.

FIG. 3 is an explanatory view of a configuration of the underground pipeline removal device.

FIG. 4 is a diagram illustrating cutting of the underground pipe by a cutting device.

FIG. 5 is a diagram illustrating insertion of the heating device into the underground pipe.

FIG. 6 is a diagram illustrating heating of the underground pipe by the heating device.

FIG. 7 is a diagram illustrating insertion of the collection device into the underground pipe.

FIG. 8 is a diagram illustrating an aspect in which an anchor portion is engaged with a cut piece of the underground pipe at a back side end portion of the underground pipe.

FIG. 9 is a diagram illustrating an aspect in which a cut piece of the underground pipe is drawn into the underground pipe from a back side of the underground pipe.

FIG. 10 is a diagram illustrating an aspect of drawing out a cut piece from an opening at an end portion of the underground pipe to the outside through the inside of the underground pipe.

FIG. 11 is a diagram illustrating an aspect in a case where the insertion of the cutting device, the insertion of the heating device, and the insertion of the collection device into the underground pipe are simultaneously performed.

FIG. 12 is a diagram illustrating an aspect in a case where cutting of the underground pipe, heating of the underground pipe, and drawing out of the underground pipe are simultaneously performed.

### DESCRIPTION OF EMBODIMENTS

An underground pipeline removal method and an underground pipeline removal device according to the embodiment of the present invention will be described with reference to the drawings.

### (Outline Description)

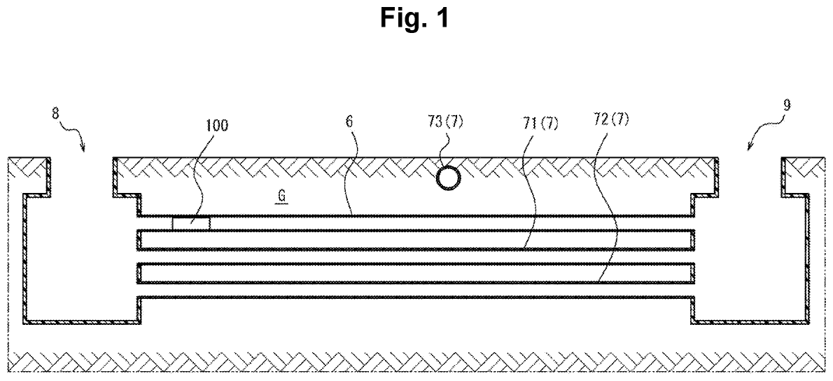

As illustrated in FIG. 1, the underground pipeline removal device 100 (hereinafter, simply referred to as a removal device 100) is an example of a device capable of realizing the underground pipeline removal method of the present embodiment. As described later, the removal device 100 can selectively remove only the underground pipe 6 (examples of an underground pipeline and a pipeline) embedded in the ground G. The underground pipe 6 is an example of an unnecessary pipeline to be removed in the present embodiment.

FIG. 1 illustrates an example of the embedded state of the underground pipe 6. The underground pipe 6 is embedded to bridge between a pair of manholes 8 and 9. Hereinafter, in the underground pipe 6, the manhole 8 side may be referred to as a front side, and the manhole 9 side may be referred to as a back side. The removal device 100 is used by being inserted into the inside of the tube of the underground pipe 6 (hereinafter, it is simply described as the inside of the underground pipe 6) from the front side of the underground pipe 6.

In the vicinity of the underground pipe 6, another underground pipe 7 that is not a removal target is embedded. In the example illustrated in FIG. 1, the underground pipes 71 and 72 embedded so as to bridge between the pair of manholes 8 and 9 along the extending direction of the underground pipe 6 and the underground pipe 73 embedded to intersect the extending direction of the underground pipe 6 are illustrated as the underground pipe 7. When the removal work of the underground pipe 6 is performed, these underground pipes 7 must not be destroyed, and the removal work of the underground pipe 6 must not have an influence such that the embedded state of the underground pipe 7 changes after the removal of the underground pipe 6. That is, these underground pipes 7 should not be damaged during the removal work of the underground pipes 6.

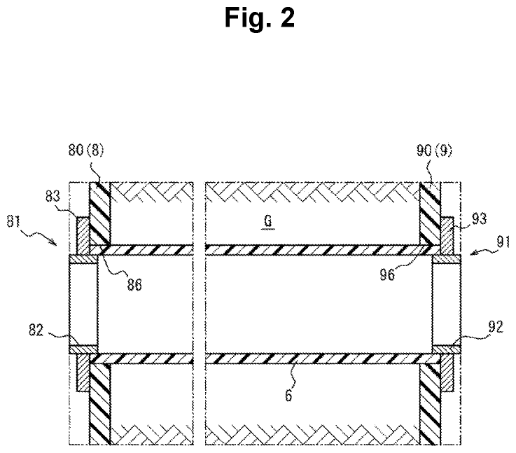

As illustrated in FIG. 2, the removal device 100 includes a cutting device 1 that is inserted into the underground pipe 6 from the front side and spirally cuts the underground pipe 6 from the inside to form a strip-like cut piece, and a collection device 3 that draws out the cut piece from the front side to the outside through the inside of the underground pipe 6.

The removal device 100 can realize the underground pipeline removal method according to the present embodiment. That is, the removal device 100 can realize execution of an insertion process of inserting the cutting device 1 into the underground pipe 6 from the front side toward the back side of the underground pipe 6, a cutting process of spirally cutting the underground pipe 6 from the inside with the cutting device 1 to form a strip-like cut piece, and a collection process of drawing out the cut piece of the underground pipe 6 from the front side to the outside through the inside of the underground pipe 6.

### DETAILED DESCRIPTION

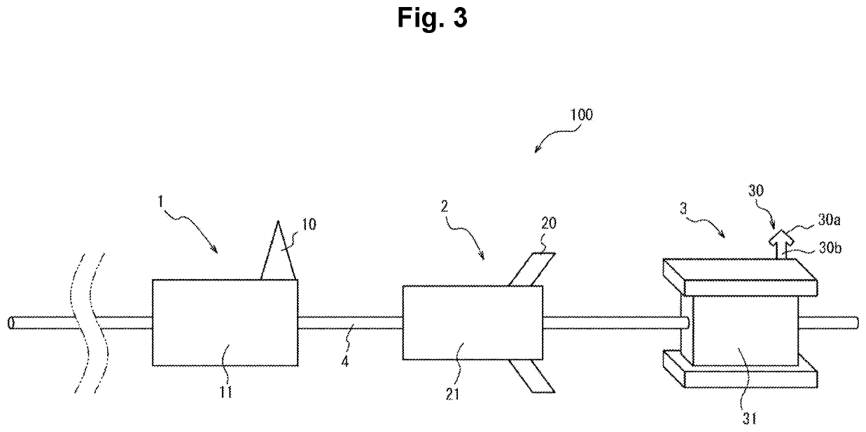

As described above, the underground pipe 6 to be removed is embedded so as to bridge between the pair of manholes 8 and 9 as illustrated in FIG. 1. FIG. 3 is an enlarged view of a connection portion between the underground pipe 6 and the pair of manholes 8 and 9 in the underground pipe 6. The underground pipe 6 of the present embodiment is used to house, for example, a communication line and a power line. Prior to removal of the underground pipe 6, the communication line and the power line housed in the underground pipe 6 are removed in advance. The underground pipe 6 is a metal pipe such as a steel pipe or a resin pipe such as a vinyl chloride pipe (so-called vinyl chloride pipe). In the present embodiment, a case where the underground pipe 6 is a vinyl chloride pipe will be described below as an example.

Through holes 86 and 96 into which end portions of the underground pipe 6 are fitted are formed in the side walls 80 and 90 of the manholes 8 and 9. Both end portions of the underground pipe 6 are fitted into the through holes 86 and 96, respectively. Both end portions of the underground pipe 6 are covered with covers 81 and 91 from the internal space side of the manholes 8 and 9. The covers 81 and 91 include, for example, sleeves 82 and 92 fitted inside the tube of the underground pipe 6, and lid portions 83 and 93 extending radially outward from the side walls of the sleeves 82 and 92. The lid portions 83 and 93 cover the end portion of the underground pipe 6 and portions of the side walls 80 and 90 in the vicinity of the outer periphery of the end portion of the underground pipe 6 from the internal space side of the manholes 8 and 9. That is, in the case illustrated in FIG. 3, the end portion of the underground pipe 6 is not exposed to the internal space side of the manholes 8 and 9. Therefore, even in a case where a worker or the like enters the manholes 8 and 9, the worker cannot directly access the end portion of the underground pipe 6. The inside of the underground pipe 6 is open to the internal spaces of the manholes 8 and 9, and the inside of the underground pipe 6 communicates with the internal spaces of the manholes 8 and 9. Note that, although not illustrated in FIG. 1, sandy soil is often used for soil in the vicinity of the end portion of the underground pipe 6 or in the vicinity of the end portions of the covers 81 and 91. Hereinafter, a case where the soil in the vicinity of the end portion of the underground pipe 6 and in the vicinity of the end portions of the covers 81 and 91 is sand and easily collapses will be described as an example.

As illustrated in FIG. 2, the removal device 100 according to the present embodiment further includes a heating device 2 that heats the underground pipe 6, and a support shaft 4 that supports the cutting device 1, the heating device 2, and the collection device 3, in addition to the cutting device 1 and the collection device 3 described above. The cutting device 1, the heating device 2, the collection device 3, and the support shaft 4 are used by being inserted into the underground pipe 6.

The support shaft 4 is, for example, a long rod-shaped member. As another example, the support shaft 4 may be a wire-shaped member. The support shaft 4 supports the cutting device 1, the heating device 2, and the collection device 3. The cutting device 1, the heating device 2, and the collection device 3 can be inserted into and drawn out of the underground pipe 6 while being supported by the support shaft 4.

As illustrated in FIG. 3, the cutting device 1 includes a blade portion 10 that cuts the underground pipe 6 (see FIG. 2) from the inside, and a cutting device main body 11 that supports the blade portion 10 and allows the blade portion 10 to rotate inside the underground pipe 6 with the extending direction of the underground pipe 6 as a rotation axis.

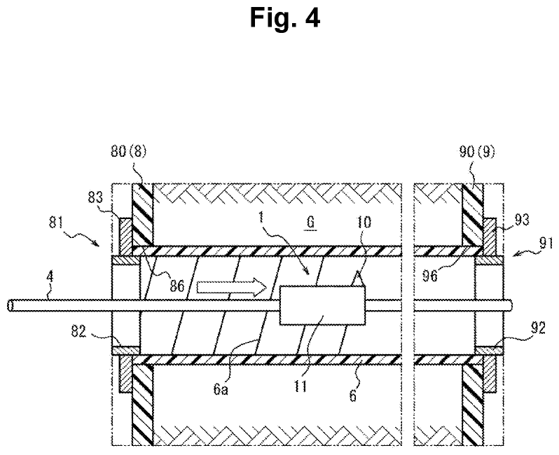

As illustrated in FIG. 4, the cutting device 1 can spirally cut the underground pipe 6 from the inside by spirally moving the blade portion 10 with respect to the inner wall surface of the underground pipe 6 in a state where the cutting edge of the blade portion 10 is pressed against the inner wall surface of the underground pipe 6.

For example, the cutting device 1 can move the blade portion 10 in a spiral shape with respect to the inner wall surface of the underground pipe 6 by moving the cutting device main body 11 in the extending direction of the underground pipe 6 (the same as the axial direction of the support shaft 4) along the support shaft 4 while rotating the cutting device main body 11 with the support shaft 4 as a rotation axis. As an example, the cutting device 1 may have a traveling mechanism, and may travel and move in the extending direction of the underground pipe 6 using the support shaft 4 as a traveling rail. Further, the cutting device 1 may move the underground pipe 6 in the extending direction together with the support shaft 4. That is, the cutting device 1 may be moved in the extending direction of the underground pipe 6 by moving the support shaft 4 in the extending direction of the underground pipe 6.

As an example, FIG. 4 illustrates a case where the underground pipe 6 is spirally cut from the inside while the cutting device 1 is inserted into the underground pipe 6 from the front side toward the back side. In FIG. 4, a cutting line 6a indicated by a solid line indicates a cut portion in the underground pipe 6. The cutting line 6a draws a spiral trajectory in the underground pipe 6. That is, the underground pipe 6 is cut into a spiral cut piece with the cutting device 1. After the cutting device 1 is once inserted to the back side, the underground pipe 6 may be spirally cut from the inside while the cutting device 1 is pulled out to the front side.

As illustrated in FIG. 3, the collection device 3 includes an anchor portion 30 that engages with a cut piece of the underground pipe 6, and a pulling portion 31 that draws out the anchor portion 30 to the outside from an opening at the end portion on the front side of the underground pipe 6 through the inside of the underground pipe 6. The collection device 3 is a device that draws out a cut piece (see FIG. 4) of the underground pipe 6 to the outside of the underground pipe 6 from an opening at the end portion on the front side of the underground pipe 6.

The anchor portion 30 is a member having a wire-shaped or rod-shaped pulling member 30b in which the distal end portion 30a is, for example, a spear-shaped or hook-shaped engagement portion. The pulling portion 31 is connected on the root side of the pulling member 30b. The anchor portion 30 engages the distal end portion 30a with the cut piece of the underground pipe 6. The anchor portion 30 is preferably engaged with the cut piece of the underground pipe 6 on the back side of the underground pipe 6, particularly at the back side end portion of the underground pipe 6. The anchor portion 30 can engage the distal end portion 30a with the cut piece of the underground pipe 6 by, for example, piercing the spear-shaped distal end portion 30a into the cut piece of the underground pipe 6 or hooking the hook-shaped distal end portion 30a on the cut piece of the underground pipe 6. In the present embodiment, hereinafter, a case where the distal end portion 30a of the anchor portion 30 has a spear shape will be described as an example.

The pulling portion 31 supports the anchor portion 30, and draws out the anchor portion 30 from the opening at the end portion on the front side of the underground pipe 6 to the outside. As a result, the cut piece (see FIG. 4) of the underground pipe 6 can be drawn out to the outside of the underground pipe 6 from the opening at the end portion on the front side of the underground pipe 6. Hereinafter, drawing out the cut piece of the underground pipe 6 from the opening at the end portion on the front side of the underground pipe 6 to the outside of the underground pipe 6 may be simply referred to as removal of the underground pipe 6.

The collection device 3 can pull out the anchor portion 30 toward the front side and draw out the anchor portion 30 to the outside, for example, by moving the pulling portion 31 toward the front side in the extending direction of the underground pipe 6 along the support shaft 4.

As for the movement of the collection device 3, for example, the collection device 3 may have a travel mechanism and may travel and move in the extending direction of the underground pipe 6 with the support shaft 4 as a traveling rail. In addition, the collection device 3 may move in the extending direction of the underground pipe 6 together with the support shaft 4. That is, the collection device 3 may be moved in the extending direction of the underground pipe 6 by moving the support shaft 4 in the extending direction of the underground pipe 6.

The pulling portion 31 may include an injection mechanism that injects the distal end portion 30a of the anchor portion 30 toward the underground pipe 6. The pulling portion 31 may inject the distal end portion 30a of the anchor portion 30 toward the underground pipe 6 by the injection mechanism, and pierce the distal end portion 30a of the anchor portion 30 into the underground pipe 6 to engage the anchor portion 30 with the underground pipe 6.

As illustrated in FIG. 3, the heating device 2 includes a nozzle portion 20 that supplies water vapor to the inside of the underground pipe 6, and a heating device main body 21 that supports the nozzle portion 20. The heating device 2 can supply water vapor supplied from the nozzle portion 20 to an arbitrary portion of the inner wall surface of the underground pipe 6 by moving the heating device main body 21 in the extending direction of the underground pipe 6 along the support shaft 4, for example.

As for the movement of the heating device 2, for example, the heating device 2 may have a travel mechanism and may travel and move in the extending direction of the underground pipe 6 with the support shaft 4 as a traveling rail. Further, the heating device 2 may move in the extending direction of the underground pipe 6 together with the support shaft 4. That is, the heating device 2 may be moved in the extending direction of the underground pipe 6 by moving the support shaft 4 in the extending direction of the underground pipe 6.

The nozzle portion 20 is a steam nozzle for ejecting (supplying) water vapor. The nozzle portion 20 can heat and soften the underground pipe 6 by supplying water vapor to the inside of the underground pipe 6. As a result, when the underground pipe 6 is removed, the cut piece of the underground pipe 6 can be softened to facilitate drawing of the cut piece of the underground pipe 6 to the outside of the underground pipe 6. Water vapor can be supplied to nozzle portion 20 through a flexible pipe having heat resistance and pressure resistance.

The water vapor supplied from the nozzle portion 20 into the underground pipe 6 is preferably so-called superheated steam. By using the superheated steam, a large amount of heat can be easily supplied to the underground pipe 6, and the underground pipe 6 can be quickly softened. The temperature of the superheated steam is preferably, for example, 100° C. or higher and 150° C. or lower. If the temperature of the superheated steam is lower than 100° C., the underground pipe 6 may not be sufficiently softened. When the temperature of the superheated steam exceeds 150° C., the underground pipe 6 may be thermally melted.

In the following, the underground pipeline removal method according to the present embodiment will be described in detail by exemplifying the case where the underground pipeline removal device 100 is used.

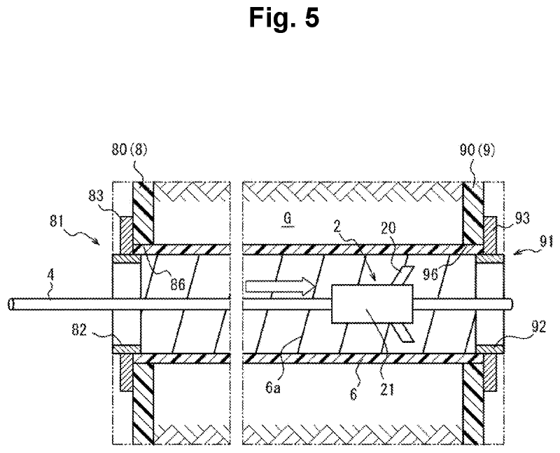

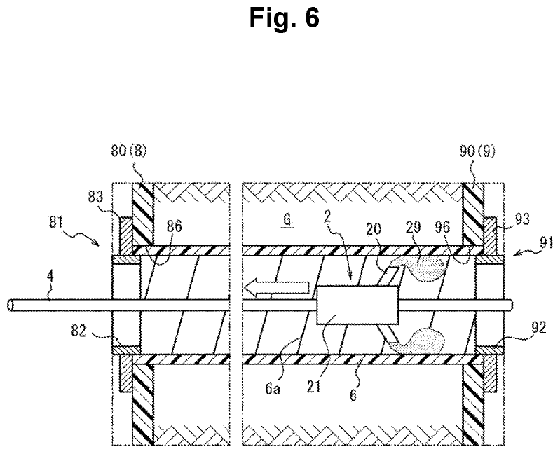

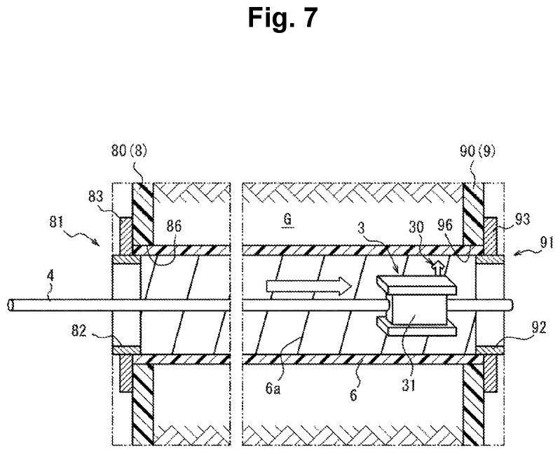

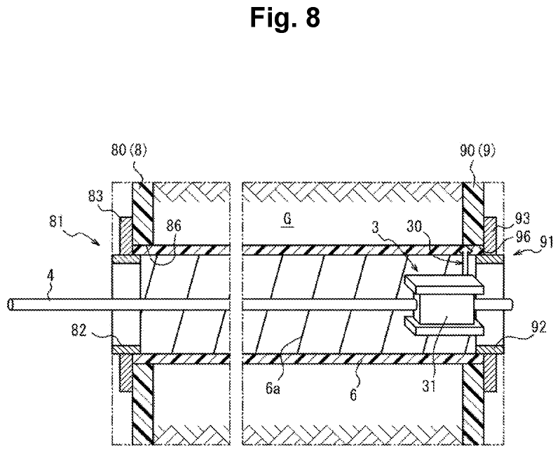

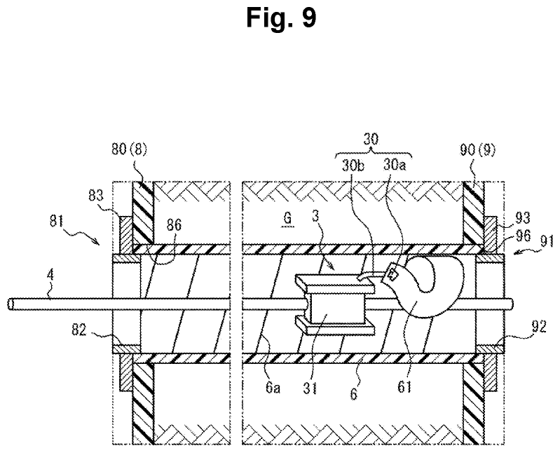

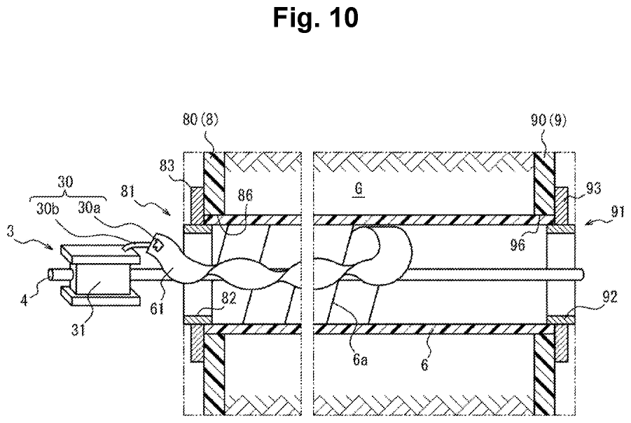

As an example, the removal method of the underground pipe according to the present embodiment includes an insertion process (see FIG. 4) of inserting the cutting device 1 into the underground pipe 6 from the front side to the back side of the underground pipe 6, a cutting process (see FIG. 4) of spirally cutting the pipe wall of the underground pipe 6 from the inside with the cutting device 1 inserted into the underground pipe 6 to form strip-like cut pieces, a process (see FIG. 5) of inserting the heating device 2 into the underground pipe 6 from the front side of the underground pipe 6, a heating process (see FIG. 6) of heating the underground pipe 6 from the inside by the heating device 2 inserted into the underground pipe 6, a process (see FIG. 7) of inserting the collection device 3 into the underground pipe 6 from the front side of the underground pipe 6, and a collection process (see FIGS. 9 and 10) of engaging the anchor portion 30 of the collection device 3 inserted into the underground pipe 6 with the cut piece of the underground pipe 6 (see FIG. 8) and drawing out the cut piece of the underground pipe 6 from the front side to the outside through the inside of the underground pipe 6.

Hereinafter, as illustrated in FIG. 5, the process of inserting the heating device 2 into the underground pipe 6 may be referred to as a heating device insertion process. In addition, as illustrated in FIG. 7, the process of inserting the collection device 3 into the underground pipe 6 may be referred to as a collection device insertion process. In order to distinguish from these two processes, the insertion process of inserting the cutting device 1 may be referred to as a cutting device insertion process.

In the insertion process (cutting device insertion process) illustrated in FIG. 4, as already described in the description of the cutting device 1, the underground pipe 6 may be spirally cut from the inside while the cutting device 1 is inserted into the underground pipe 6 from the front side toward the back side. In addition, after the cutting device 1 is once inserted to the back side, the underground pipe 6 may be spirally cut from the inside while the cutting device 1 is pulled out to the front side. Since the underground pipe 6 is cut from the inside, the underground pipe 7 (see FIG. 1) adjacent to the underground pipe 6 is not damaged when the underground pipe 6 is cut.

In the heating process, as already described in the description of the heating device 2, water vapor is supplied to the inside of the underground pipe 6 to heat and soften the underground pipe 6 (see FIG. 6). FIG. 6 illustrates a case where steam flow 29 of water vapor is discharged from nozzle portion 20 and supplied. Since the underground pipe 6 is heated from the inside, the underground pipe 7 (see FIG. 1) adjacent to the underground pipe 6 is not damaged when the underground pipe 6 is heated. The water vapor is preferably supplied while the heating device 2 is once inserted to the back side and then pulled out to the front side. As a result, the underground pipe 6 can be heated with high work efficiency. Water vapor may be supplied while the heating device 2 is inserted from the water vapor front side toward the back side. In this case, it is preferable to continue the supply of water vapor even when the heating device 2 is pulled out to the front side after being inserted to the back side. This makes it possible to prevent the underground pipe 6 from being cooled before the collection process is performed.

The heating process is preferably performed after the cutting process. This makes it possible to prevent the underground pipe 6 from being cooled before the collection process is performed. When the heating process is performed before the cutting process, cutting in the cutting process may be facilitated due to softening of the underground pipe 6.

In the collection process, the anchor portion 30 may be engaged with the cut piece of the underground pipe 6 at the back side of the underground pipe 6, particularly at the back side end portion of the underground pipe 6 (see FIG. 8). Then, the pulling portion 31 is moved to the front side (see FIG. 9), and the pulling portion 31 is drawn out to the outside from the opening at the end portion on the front side of the underground pipe 6 (see FIG. 10). As a result, the anchor portion 30 can be drawn out to the outside from the opening at the end portion on the front side of the underground pipe 6, the cut piece of the underground pipe 6 can be drawn into the underground pipe 6 from the back side of the underground pipe 6, and the cut piece can be drawn out to the outside from the opening at the end portion of the underground pipe 6 on the front side via the inside (removing of the underground pipe 6 is performed) (see FIGS. 9 and 10). A state where all the cut pieces are drawn out to the outside of the underground pipe 6 (the outside of the space portion where the underground pipe 6 was embedded) is a state where the underground pipe 6 is completely drawn out from the ground G (see FIG. 1). Thereafter, the underground pipe 6 can be collected from the inside of the manhole 8.

Here, as described above, by engaging the anchor portion 30 with the cut piece of the underground pipe 6 on the back side of the underground pipe 6 (particularly, at the back side end portion of the underground pipe 6), the underground pipe 6 can be easily removed. This is because the anchor portion 30 is engaged with the cut piece of the underground pipe 6 at the back side end portion of the underground pipe 6, so that the cut piece can be drawn out to the outside in order from the cut piece at the back side end portion, and the cut piece can be smoothly drawn out to the outside without being entangled inside the underground pipe 6.

By engaging the anchor portion 30 with the cut piece of the underground pipe 6 at the back side end portion of the underground pipe 6, the underground pipe 6 can be easily removed also in the following points. That is, since the underground pipe 6 can be drawn out to the outside in order from the cut piece of the back side end portion, the front side end portion of the underground pipe 6 is maintained in a state where the shape of the pipe is maintained until the final stage of removal of the underground pipe 6. Therefore, a path (that is, the internal space of the underground pipe 6) for drawing out the cut piece to the outside can be secured until the final stage of removal of the underground pipe 6. As described above, the soil in the vicinity of the end portion of the underground pipe 6 and in the vicinity of the end portions of the covers 81 and 91 is sand and easily collapses. If the front side end portion of the underground pipe 6 is not maintained in a state where the shape of the pipe is maintained until the final stage of removal of the underground pipe 6, the soil may collapse in the middle stage of removal of the underground pipe 6, and removal of the underground pipe 6 may be interrupted. However, the front side end portion of the underground pipe 6 is maintained in a state where the shape of the pipe is maintained until the final stage of removal of the underground pipe 6, whereby collapse of the surrounding soil can be prevented. This makes it possible to secure a path for drawing out the cut piece to the outside until the final stage of removal of the underground pipe 6. Accordingly, this facilitates removal of the underground pipe 6.

Since the cut piece of the underground pipe 6 is drawn out to the outside through the inside of the underground pipe 6, the underground pipe 7 (see FIG. 1) adjacent to the underground pipe 6 is not damaged when the underground pipe 6 is removed. In addition, the adjacent underground pipes 7 are not damaged also in that the underground pipes 6 are removed while the collapse of the surrounding soil is prevented.

In the underground pipeline removal method according to the present embodiment, after the cutting device insertion process and the cutting process are performed, the heating device insertion process and the heating process are performed, and then the collection device insertion process and the collection process can be performed. That is, in the underground pipeline removal method according to the present embodiment, the cutting device insertion process, the cutting process, the heating device insertion process, the heating process, the collection device insertion process, and the collection process may be performed in this order.

### Description of Modification Example

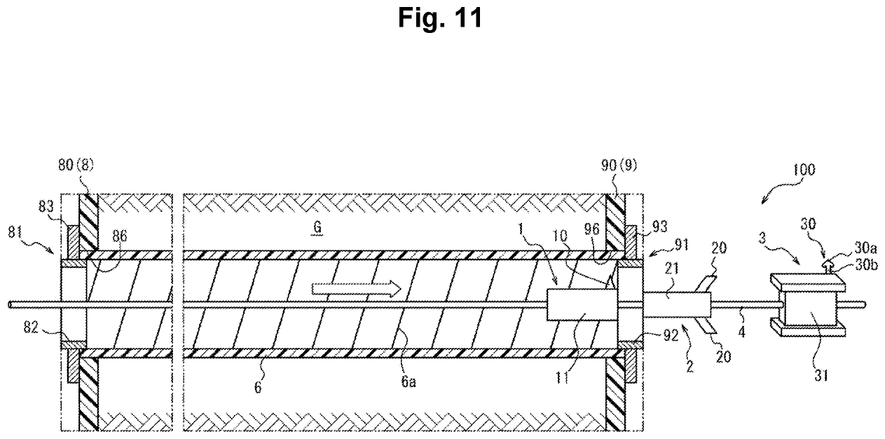

In the underground pipeline removal method according to the present embodiment, the cutting device insertion process, the cutting process, the heating device insertion process, the heating process, the collection device insertion process, and the collection process are not limited to be performed in this order, and the cutting device insertion process, the heating device insertion process, and the collection device insertion process may be performed simultaneously as illustrated in FIG. 11.

When the cutting device insertion process, the heating device insertion process, and the collection device insertion process are performed simultaneously (hereinafter described above the case of simultaneous insertion), the cutting device 1, the heating device 2, and the collection device 3 can be arranged in this order from the front side to the back side. In the case of simultaneous insertion, the heating device 2 and the collection device 3 are allowed to be temporarily pushed out into the manhole 9 on the back side in the cutting device insertion process.

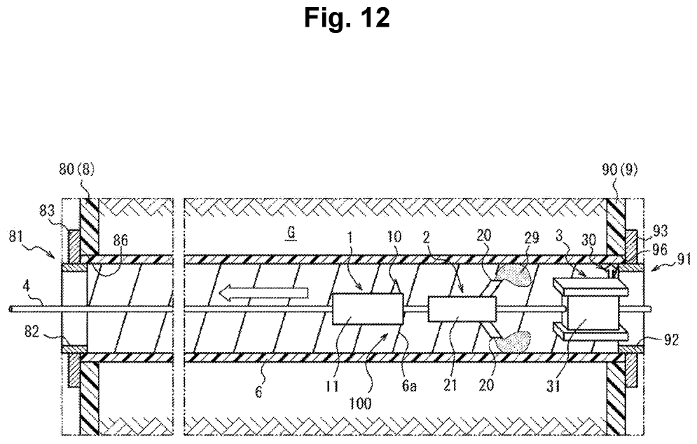

In the case of simultaneous insertion, as illustrated in FIG. 12, the cutting process, the heating process, and the collection process may be performed simultaneously. That is, while the underground pipe 6 is cut with the cutting device 1, the cut pieces of the cut underground pipe 6 may be sequentially heated by the heating device 2, and the heated cut pieces may be drawn out by the collection device 3.

As described above, it is possible to provide an underground pipeline removal device and an underground pipeline removal method capable of selectively removing only unnecessary pipelines.

### Another Embodiment

(1) In the above embodiment, the case where the heating device insertion process and the heating process are performed has been described as an example, but the heating process is not essential. For example, in a case where the underground pipe 6 is a steel pipe, the heating process may not be performed. In the above embodiment, the case where the removal device 100 includes the cutting device 1, the heating device 2, and the collection device 3 has been described as an example. However, when the heating process is not performed, the removal device 100 may not include the heating device 2.

(2) In the above embodiment, the case where the underground pipe 6 is heated with water vapor in the heating process has been described. However, the heating of the underground pipe 6 is not limited to the case of using water vapor. For example, the underground pipe 6 may be heated by irradiation with infrared rays, or the underground pipe 6 may be heated by causing a heat medium such as high-temperature oil to flow therethrough. In addition, hot air may be caused to flow through the underground pipe 6.

Note that the configuration disclosed in the above embodiment (including another embodiment; the same applies hereinafter) can be applied in combination with the configuration disclosed in other embodiments as long as there is no contradiction, and the embodiment disclosed in the present specification is an example, and the embodiment of the present invention is not limited thereto, and can be appropriately modified without departing from the object of the present invention.

### INDUSTRIAL APPLICABILITY

The present invention can be applied to an underground pipeline removal method and an underground pipeline removal device capable of selectively removing only unnecessary pipelines.

### REFERENCE SIGNS LIST

1 Cutting device
10 Blade portion
100 Removal device (underground pipeline removal device)
11 Cutting device main body
2 Heating device
20 Nozzle portion
21 Heating device main body
29 Steam flow
3 Collection device
30 Anchor portion
30a Distal end portion
30b Pulling member
31 Pulling portion
4 Support shaft
6 Underground pipe (pipeline)
6a Cutting line
7 Underground pipe
71 Underground pipe
73 Underground pipe
8 Manhole
80 Sidewall
81 Cover
82 Sleeve
83 Lid portion
86 Through hole
9 Manhole
G Underground

1. A method for removing an underground pipeline, comprising:
an insertion process of inserting a cutting device into a pipeline from a front side toward a back side of the pipeline;
a cutting process of spirally cutting the pipeline from the inside with the cutting device to form cut pieces, wherein the cut pieces are in strip-like form; and
a collection process of drawing out the cut pieces from the front side to an outside through an inside of the pipeline.

2. The method according to claim 1, wherein in the collection process, the cut pieces are drawn into the pipeline from the back side of the pipeline, and the cut pieces are drawn to the outside from an opening at an end portion of the pipeline on the front side through the inside.

3. The method according to claim 2, wherein in the collection process, an anchor portion is engaged with the cut pieces on the back side, and the anchor portion is drawn out to the outside from an opening at the end portion on the front side of the pipeline to draw out the cut pieces to the outside.

4. The method according to claim 1, further comprising:
a heating process of heating the pipeline, wherein
the collection process is performed after the heating process.

5. The method according to claim 4, wherein in the heating process, the pipeline is heated with water vapor.

6. A device for removing an underground pipeline, comprising:
a cutting device that is inserted into pipeline from a front side of the pipeline and cuts the pipeline spirally from the inside to form a strip-like cut piece; and
a collection device that draws out the cut pieces from the front side to an outside through an inside of the pipeline.

7. The device according to claim 6, wherein the collection device includes:
an anchor portion that engages with the cut pieces on a back side of the pipeline; and
a pulling portion that draws out the anchor portion from an opening at the end portion on the front side of the pipeline to an outside through an inside of the pipeline.

8. The device according to claim 7, further comprising:
a heating device that heats the pipeline, wherein
the heating device includes a nozzle portion that supplies water vapor to the inside of the pipeline to heat the inside of the pipeline.

9. The method according to claim 1, wherein the cutting device includes a blade portion, and the blade portion rotates inside the pipeline with the extending direction of the pipeline as a rotation axis for spirally cutting the pipeline from inside the pipeline into the cut pieces.

10. The method according to claim 1, wherein, in the cutting process, the cutting device moves from the front side of the pipeline toward the backside of the pipeline while spirally cutting the pipeline.

11. The method according to claim 1, wherein, in the collection process, the cutting device moves toward the front side of the pipeline.

12. The method according to claim 1, wherein the cutting device attaches to a support shaft, wherein the support shaft includes a wire-shaped member for supporting the cutting device inside the pipeline.

13. The method according to claim 1, wherein the collection process uses a collection device to draw out the cutting pieces, and wherein the collection device attaches to a support shaft, wherein the support shaft includes a wire-shaped member for supporting the collection device inside the pipeline.

14. The method according to claim 1, wherein the pipeline is embedded underground.

15. The method according to claim 4, wherein the heating process uses a heating device to heat the pipeline, and wherein the heating device attaches to a support shaft, wherein the support shaft includes a wire-shaped member for supporting the heating device inside the pipeline.

16. The method according to claim 4, wherein the heating process softens the pipeline for drawing out the cut pieces from the front side of the pipeline.
